(19) United States
(12) Patent Application Publication
(10) Pub. No.: US 2013/0222175 A1
(43) Pub. Date: Aug. 29, 2013

(54) SPEED LIMITATION SYSTEM

(71) Applicants: Collyer Allen Smith, Ann Arbor, MI (US); Collyer Campbell Smith, Ann Arbor, MI (US)

(72) Inventors: Collyer Allen Smith, Ann Arbor, MI (US); Collyer Campbell Smith, Ann Arbor, MI (US)

(21) Appl. No.: 13/405,205

(22) Filed: Feb. 24, 2012

(51) Int. Cl. G01S 13/02

(52) U.S. Cl. 342/70

(57) ABSTRACT

The present invention is a speed limitation system utilized in combination with a vehicle with a front that includes a speed limit sign that includes a barcode that indicates a predetermined speed limit with number and letter indicia indicating the predetermined speed limit and a radar producing device that is disposed on the vehicle and produces a radar beam that is emitted and directed at the barcode of the speed limit sign. The system also includes a radar receiving device that is disposed on the vehicle and receives the radar signal with the predetermined speed limit and an engine control device that is in communication with the radar receiving device and transmits the received predetermined speed limit and controls the vehicle's engine speed so the vehicle travels within or at the predetermined speed limit.

### TECHNICAL FIELD & BACKGROUND

Drivers may not always observe the posted speed limit on the highway or street, in an effort to swiftly reach their destination. If an individual chooses to drive too fast and exceed a posted speed limit while on the road it may lead to a vehicular accident causing damage and time delays for others.

The present invention generally relates to a speed related system. More specifically, the invention is a speed limitation system.

It is an object of the invention to provide a speed limitation system that can automatically limit a vehicle's maximum traveling speed.

It is an object of the invention to provide a speed limitation system that helps prevent vehicle speed related accidents.

It is an object of the invention to provide a speed limitation system that manages and controls a plurality of a vehicle's maximum traveling speeds utilizing a plurality of speed limit signs.

What is really needed is a speed limitation system that can automatically limit a vehicle's maximum traveling speed that help prevent vehicle speed related accidents that manages and controls a plurality of a vehicle's maximum traveling speeds utilizing a plurality of speed limit signs.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a side perspective view of a speed limitation system, according to an embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

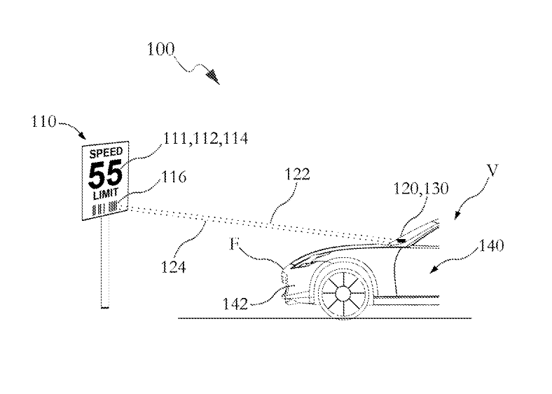

FIG. 1 illustrates a side perspective view of a speed limitation system 100, according to an embodiment of the present invention. The speed limitation system 100 automatically limits a vehicle's V maximum traveling speed that helps prevent vehicle speed related accidents that manages and controls a plurality of a vehicle's maximum traveling speeds. The vehicle V can be an automobile A, a truck T such as a pick-up truck PT, a van V, a recreational vehicle RV, a commercial truck CT or other suitable vehicle.

The speed limitation system 100 includes a speed limit sign 110, a radar producing device 120, a radar receiving device 130 and an engine control device 140. The speed limit sign 110 has a front facing 111 that can be any suitable speed limit sign that indicates a predetermined speed limit 112, such as 55 miles per hour MPH, as illustrated in FIG. 1 or other suitable predetermined speed limits such as 10 MPH, 15 MPH, 20 MPH, 25 MPH, 30 MPH, 35 MPH, 40 MPH, 50 MPH, 60 MPH and 65 MPH typically with number and letter indicia 114 indicating the predetermined speed limit 112. The speed limit sign 110 includes a barcode 116 disposed on the front facing 111 of the speed limit sign 110. The radar producing device 120 is disposed on the front F of the vehicle V and produces a radar beam 122 that is emitted and directed at the front facing 111 and the barcode 116 of the speed limit sign 110. The barcode 116 receives the radar beam 122 and emits a radar signal 124 back to the vehicle V with the predetermined speed limit 112. The radar receiving device 130 is disposed on the front F of the vehicle V and receives the radar signal 124 with the predetermined speed limit 112. The engine control device 140 is in communication with the radar receiving device 130 and transmits the received predetermined speed limit 112. The engine control device 140 then controls the vehicle's engine 142 and vehicle's V speed so the vehicle V travels within or at the predetermined speed limit 112. The engine control device 140 is typically provided on the vehicle V before installation of the speed limitation system 100.

The speed limitation system is a system that supports safe driving. The radar producing device is approximately 6-½″ wide by 3-½″ long and emits a radar beam to scan a barcode's disposed on the front of the speed limit signs. Once the radar receiver captures the miles per hour the vehicle should be going, it will use the engine control device to reduce the speed. Parents of teen drivers are among the many people who may find the speed limitation system both effective and convenient to use. The speed limitation system features a radar beam emitted from a radar producing device to scan a barcode posted on speed signs on the road. The speed limitation system relatively quickly and safely modifies a vehicle's speed so that it is in compliance with the rules of the road.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A speed limitation system utilized in combination with a vehicle with a front, comprising:
a speed limit sign with a front facing that includes a barcode that indicates a predetermined speed limit with number and letter indicia indicating said predetermined speed limit;
a radar producing device that is disposed on said front of said vehicle and produces a radar beam that is emitted and directed at said front facing and said barcode of said speed limit sign;
a radar receiving device that is disposed on said front of said vehicle and receives said radar signal with said predetermined speed limit; and
an engine control device that is in communication with said radar receiving device and transmits said received predetermined speed limit and controls said vehicle's engine and said vehicle's speed so said vehicle travels within or at said predetermined speed limit.

2. The system according to claim 1, wherein said barcode is disposed on said front facing of said speed limit sign.

3. The system according to claim 1, wherein said barcode receives said radar beam and emits a radar signal back to said vehicle with said predetermined speed limit.

4. The system according to claim 1, wherein said radar producing device is approximately 6-½″ wide by 3-½″ long.

5. The system according to claim 1, wherein said vehicle is an automobile.

6. The system according to claim 1, wherein said vehicle is vehicle a truck.

7. The system according to claim 6, wherein said vehicle is a pick-up truck.

8. The system according to claim 6, wherein said vehicle is a commercial truck.

9. The system according to claim 1, wherein said vehicle is a van.

10. The system according to claim 1, wherein said vehicle is a recreational vehicle.

11. A speed limitation system utilized in combination with a vehicle with a front, comprising:
a speed limit sign with a front facing that includes a barcode disposed on said front facing that indicates a predetermined speed limit with number and letter indicia indicating said predetermined speed limit;
a radar producing device that is disposed on said front of said vehicle and produces a radar beam that is emitted and directed at said front facing and said barcode of said speed limit sign and said barcode receives said radar beam and emits a radar signal back to said vehicle with said predetermined speed limit;
a radar receiving device that is disposed on said front of said vehicle and receives said radar signal with said predetermined speed limit; and
an engine control device that is in communication with said radar receiving device and transmits and controls said received predetermined speed limit to said vehicle's engine and said vehicle's speed so said vehicle travels within or at said predetermined speed limit.

12. The system according to claim 11, wherein said radar producing device is approximately 6-½″ wide by 3-½″ long.

13. The system according to claim 11, wherein said predetermined speed limit is approximately 10 MPH, 15 MPH, 20 MPH, 25 MPH, 30 MPH, 35 MPH, 40 MPH, 50 MPH, 60 MPH or 65 MPH

14. The system according to claim 11, wherein said engine control device is provided on said vehicle before installation of said speed limitation system.

15. The system according to claim 11, wherein said vehicle is an automobile.

16. The system according to claim 11, wherein said vehicle is vehicle a truck.

17. The system according to claim 16, wherein said vehicle is a pick-up truck.

18. The system according to claim 16, wherein said vehicle is a commercial truck.

19. The system according to claim 11, wherein said vehicle is a van.

20. The system according to claim 11, wherein said vehicle is a recreational vehicle.
